(19) United States
(12) Patent Application Publication
(10) Pub. No.: US 2013/0191026 A1
(43) Pub. Date: Jul. 25, 2013

(54) Navigation system with a Personality

(71) Applicant: Haidar Ahmad, (US)

(72) Inventor: Haidar Ahmad, (US)

(21) Appl. No.: 13/358,098

(22) Filed: Jan. 25, 2012

(51) Int. Cl. G06F 17/20

(52) U.S. Cl. CPC G06F 17/20
USPC 701/538

(57) ABSTRACT

A navigation system should have a personality. That includes responses to and comments on driver's requests and actions whether right or wrong. The navigation system can call the driver/navigator by name, nickname or a swearword depending on the settings instilled by the user and the “Mood” of the device. The term “Navigation System” here applies to any device used to navigate movement from one please to another whether car navigation system or mobile phone navigation systems. It is also suggested here that a car can greet the driver with her/his name The car can save and deploy driver-specific settings like climate control setting, radio station setting, and audio system settings. The navigation system can be a good place to enter, save and deploy those settings.

### FIELD OF INVENTION

The present invention relates to Navigation systems in general (built in, portable or mobile phone navigation system). The invention also deals with driver-specific settings in the car including the navigation systems

### DESCRIPTION OF THE RELATED ART

There is a lot more to car driver-specific settings than seat and mirror positions, so more settings are suggested. Also Navigation systems have moved from a luxury item to more of a necessity and standard feature in a car. Most smart mobile phones today have some version of a navigation system. These navigation systems are very useful but they are bland and far from being entertaining. They lack personality and no matter what you do, their response is almost very predictable.

### SUMMARY OF THE INVENTION

The car should be able to store and deploy driver preferences beyond seat and mirror positions. The preferences like climate control preferences and audio system preferences should be stored and deployed alongside seating and mirror positions with the same press of the button. The navigation system should be modified so it can be personalized. What we are suggesting is to modify the existing navigation systems software (and maybe hardware) to be more personalized and become an item of entertainment as well as a useful utility. This navigation system will call you by your name rather than talking to an anonymous person. The navigation system can be used to inform the car about who is driving and what her/his preferences are. This navigation system has a personality which would respond differently to your actions depending on different factors and a built-in randomness that simulate a mood. This navigation system has an active behavior as opposed to the passive behavior demonstrated by the commercially available navigation systems today. If you miss your turn twice, it will respond rather angrily and might even call you a name or swear at you depending on the preferences specified by the user.

The modifications suggested above for the navigation system could apply to smart phone navigation function as well as dedicated navigation systems.

### DETAILED DESCRIPTION OF THE INVENTION

We spend a lot of time driving our cars. Some people take pride in their cars and treat it with a special attachment. Cars do not seem to reciprocate. We are suggesting that this should change. I would like my car to greet me with my name every morning or evening when I get in and out of it.

A lot of cars today are designed with the idea that after the current driver gets off there is a possibility that another driver will take command. Having said that, the seat position and the mirrors are all adjusted with press of a button and they can accommodate 2-4 drivers. These drivers sure have names and they might like it for the car to greet them by their names. The car should also store and deploy audio system settings including the pre-saved radio channel positions which could be different from one driver to the other. The car should store and deploy treble and bass settings and the distribution between front and rear speakers for the audio system which could be different from one driver to the other. To personalize those new settings the design of the radio system and the audio system needs to be changed to accommodate having more than one setting. Different drivers might have different preferences for the climate control system and these could be stored in the car. Pressing the button for retrieving seat position should bring all the above settings too. If the car has a built-in navigation system then it could be used as the console to enter, save and deploy the above mentioned driver preferences.

The Navigation system can have a set of preferences of its own (whether portable built-in or on a smart phone). These preferences could change with the driver. Sometimes we take long drives and we keep surfing radio channels looking for something amusing or something to keep us awake. The driver might like the navigation system to be more than a bland assistance device. It could be an entertainment device if we modify the navigation system to have something of a personality. For example the navigation system would throw a surprise phrase or say something nasty if the driver misses the turn twice. The language, dialect and even the accent can be personalized. There can be more than one severity level from kind reproach to sarcasm, anger or even swear words. Off course these preset position can be overridden by commands like “Kids in the car” or “Keep it polite” depending on the mood of the driver herself/himself. The navigation system itself can have different patterns of response or even randomness that simulate a mood.

To make it more personalized, the driver can save her/his phrases with their voices or any other voice.

As an example you can have a table of Event/Response to map out all the possible events with the expected response. The driver can fill that table by typing a phrase or downloading an audio file to be associated with that event. That table would be driver specific and every driver might have her/his own preferences.

1. The ability of the car to greet the driver by name or any title of her/his choice is suggested here.

2. The ability of the car to save a variety of driver-specific settings for multiple drivers is suggested here.

3. As cited in claim 2, climate settings can be saved as driver-specific settings.

4. As cited in claim 2, radio station settings can be saved as driver-specific settings.

5. As cited in claim 2, audio system settings (like treble, bass and front/rear distribution) can be saved as driver-specific settings.

6. As cited in claim 2, the navigation system settings can be saved as driver-specific settings.

7. In a car with a built-in navigation system, the navigation system itself can be used as a console to enter, save and deploy the settings in claims 1-6. If the car does not have a built-in navigation system then the same button that selects the seat position can also deploy the settings cited in claims 1-5.

8. Even if the car has a built-in navigation system, the manufacturer might chose to deploy the settings cited in claims 1-5 through the seat position selection button.

9. The navigation system whether built-in, portable or a navigation system in a mobile phone can have personalized features of its own as cited in claim 6.

10. One of the features cited in claim 9 is the ability to select language, dialect and accent.

11. Another one of the features cited in claim 9 is for the navigation system to respond to, and comment on road choices, good choices and bad choices made by the driver.

12. Responses and comments cited in claim 11 can be different levels like simple comments, sarcasm, angry comments, or even swear words.

13. Response levels cited in claim 12 are chosen by the driver and saved as part of the driver preferences.

14. The responses cited in claim 11 can come with a randomness that resembles having a mood.

15. Pre-saved response levels cited in claim 13 can be overridden by commands like “kids in the car” or “keep it polite” at the time of start-up or during operations.

16. The features cited in claim 9 can be expanded by allowing the driver to load her/his personalized responses.

17. All features cited in claims 1-16 can be password protected to avoid any tampering by non-authorized users.
